(19) United States
(12) Patent Application Publication
(10) Pub. No.: US 2007/0164059 A1
(43) Pub. Date: Jul. 19, 2007

(54) Powder delivery device

(76) Inventors: Keith Michael Rosiello, Shrewsbury, MA (US); E. Stan Eskridge JR., Chapel Hill, NC (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/653,692

(22) Filed: Jan. 16, 2007

Related U.S. Application Data
(60) Provisional application No. 60/760,858, filed on Jan. 19, 2006.

(51) Int. Cl. B05B 11/02; A01C 15/04

(52) U.S. Cl. 222/631; 222/636

(57) ABSTRACT

The present invention is directed to a powder delivery device, comprising a housing ; a plunger contained in the housing; and a dispenser component attached to an end of the housing and comprising a reservoir containing powder material; a gating component comprising a first gate having a closed end and an open end, and a second gate; a metering area between the first gate and the second gate; and one or more orifices; the gating component having a first position wherein the second gate is closed and the open end of the first gate permits the powder material to enter the metering area from the reservoir; and a second position wherein the second gate is open and the closed end of the first gate permits the powder material in the metering area to enter the housing and exit the device through the orifices. The device of the present invention can accurately dispense preselected volumes of powdered materials, such as clotting agents for wound treatment.

### CROSS-REFERENCE TO RELATED APPLICATIONS

This application claims the benefit of U.S. Provisional Application Ser. No. 60/760,858 filed Jan. 19, 2006, which is incorporated by reference herein in its entirety.

### BACKGROUND OF THE INVENTION

1. Field of the Invention

The present invention relates to powder delivery devices and more particularly to syringe-type devices for the delivery of measured doses of powdered substances with each syringe cycle.

2. Description of the Related Art

Powdered solid substances, such as coatings, therapeutic drugs, chemicals, and various hygiene and foodstuff products are well-known and commonly used materials in industrial, medical, and consumer applications. It is often necessary for reasons of function, convenience or economy, that a regulated amount, or dose, of the supply powder dispensed to the target area of application with each actuation.

Powder delivery devices are known in the prior art. For example, U.S. Pat. No. 6,799,571 discloses a medicinal delivery system for powdered medicaments that utilizes a gaseous propellant source. A flow shaper produces a vortex stream of the gaseous propellant which mixes with the medicinal powder material exiting the nozzle. The medicinal powder, gaseous propellant, and air are mixed in a vessel chamber and forced from the vessel chamber through an exit for use as a homogeneous aerosol.

U.S. Pat. No. 4,515,586 discloses a powder syringe mixing system including a pre-filled chamber having a piston plug at one end and a stopper at the other end. The chamber is filled with a powdered medicament that is to be intermixed with a diluent in a container.

U.S. Pat. No. 5,630,796 discloses a needleless syringe having a membrane which is ruptured by gas pressure to generate a supersonic gas flow in which particles containing a therapeutic agent are injected.

U.S. Pat. No. 5,273,531 discloses an apparatus to force powdered agent, such as a thrombic agent, into the operative site of a laparoscopic procedure. The device includes an elongated tube, a powder chamber and a mechanism to force the powder through the tube, including an air bulb, a syringe or a tank or cartridge of gas.

U.S. Pat. No. 4,412,836 discloses a syringe assembly comprising a casing for a medicament and having a discharge opening at one end, a diaphragm assembly mounted at the end normally sealing the contents, plunger means movable in the casing and operable upon displacement in one direction to effect increase in pressure in the casing to rupture or displace the diaphragm to permit discharge of the contents.

U.S. Pat. No. 4,405,317 discloses a syringe assembly comprising an outer barrel for a powder medicament, an inner barrel telescopically mounted in the outer barrel for diluent, and a seal means that isolates the powder and diluent compartments.

The prior art also includes devices commonly know as inhalers, which provide numerous designs for regulated and repeated powder delivery. In operation, the pressure drop induced by inhalation of the user causes air to flow through the tube and into contact with the particles of dry powder for discharging the particles for inhalation by the user. For example, U.S. Pat. No. 6.595,209 discloses a dry powder delivery system having an elongated tube containing a matrix having a measured amount of dry particles of a therapeutic compound and a porous element having a desiccant. However, inhalers have disadvantages, such as the inability to sterilize or autoclave the device, the inability to deliver different doses, the inability to deliver a concentrated powder to a limited application area, while being able to also deliver disperse powder to a broad surface area, the lack of a repeatable uniform spray, a propensity to clog, and the utilization of costly components and/or propellants. In addition, the ability to deliver a concentrated powder dose to a limited target area when held in close proximity to the target area and deliver a diffuse powder dose to a broad target area when not held in close proximity to the target area, as well as a design that reduces the propensity of clogging, is a desirable for many applications. Accordingly, there remains a need in the art for a powder delivery device that can deliver precise and large volumes of powdered products, and which addresses the limitations of the prior art devices. The present invention is believed to be an answer to these needs.

### SUMMARY OF THE INVENTION

In one aspect, the present invention is directed to a powder delivery device, comprising a housing; a plunger contained in the housing; and a dispenser component attached to an end of the housing and comprising a reservoir containing powder material; a gating component comprising a first gate having a closed end and an open end, and a second gate; a metering area between the first gate and the second gate; and one or more orifices; the gating component having a first position wherein the second gate is closed and the open end of the first gate permits the powder material to enter the metering area from the reservoir; and a second position wherein the second gate is open and the closed end of the first gate permits the powder material in the metering area to enter the housing and exit the device through the orifices.

In another aspect, the present invention is directed to a clotting agent delivery device, comprising a housing; a plunger contained in the housing; and a dispenser component attached to an end of the housing and comprising a reservoir containing a clotting material selected from the group consisting of dried platelet powder, dried red blood cell powder, fibrin powder, fibrinogen powder, thrombin powder, fibroblast growth factor-binding protein (FGF-BP) polypeptides, migration-inducing peptide fragments, diatomaceous earth, inorganic silicates, ellagic acid, epinephrine, thromboplastin, and combinations thereof; a gating component comprising a first gate having a closed end and an open end, and a second gate; a metering area between the first gate and the second gate; and one or more orifices; the gating component having a first position wherein the second gate is closed and the open end of the first gate permits the clotting material to enter the metering area from the reservoir; and a second position wherein the second gate is open and the closed end of the first gate permits the clotting material in the metering area to enter the housing and exit the device through the orifices.

In another aspect, the present invention is directed to a powder delivery device, comprising: a powder storage component having an orifice on one end of the powder storage component; and a rotatable cap positioned over the orifice, the rotatable cap having one or more arrays of passages arranged so that the arrays can be coincident with the orifice upon rotation of the cap.

In another aspect, the present invention is directed to a method of dispensing a powder material onto a target using the above devices.

In another aspect, the present invention is directed to a method of treating a bleeding wound, comprising the step of applying a clotting agent to the wound by the above devices.

In another aspect, the present invention is directed to a powder delivery device, comprising a powder storage component having an open end; and a nozzle positioned on the open end, the nozzle having a passageway having a dispensing ratio of from 0.05 to 0.5.

These and other aspects will become apparent upon reading the following detailed description of the invention.

### BRIEF DESCRIPTION OF THE FIGURES

The invention will be better understood when taken in conjunction with the figures in which:

FIG. 1 is an overall perspective view of the preferred embodiment of the disclosed invention;

FIG. 2A is an overall cross-section view of the preferred embodiment of the disclosed invention, with the plunger component fully retracted;

FIG. 2B is a detailed cross-section view of the preferred embodiment of the disclosed invention, with the plunger component fully retracted;

FIG. 3A is a detailed cross-section view of the preferred embodiment of the disclosed invention, with the gated dispensing component in the open or loaded position;

FIG. 3B is a detailed cross-section view of the preferred embodiment of the disclosed invention, with the gated dispensing component in the closed or unloaded position

FIG. 4 depicts an embodiment of the present invention incorporating an illumination source;

FIG. 5A illustrates another embodiment of the present invention;

FIG. 5B illustrates in more detail another embodiment of the present invention; and

FIG. 6 illustrates a nozzle of an alternative embodiment of the present invention.

### DETAILED DESCRIPTION OF THE INVENTION

Powdered solid substances are useful materials, especially for applications such as coatings, therapeutic drugs, chemicals, and various hygiene and foodstuff products. In many applications, a specific amount of such powders is required. For example, in medical applications, it is often necessary to provide a specific and defined amount of a therapeutic powder to treat a given disease or condition. Application of specific amounts of such powders is particularly important in the medical field because over- or under-dosing can result in ineffectual treatment, or complications. However, application of preselected measured amounts of powder is often difficult due to the nature of the powders and their inherent properties. The present inventors have developed a device for delivery of powdered materials that provides a simple, low-cost, scalable solution to repeatedly dispense a measured amount of various powdered solid substances, and address the limitations of the prior art devices.

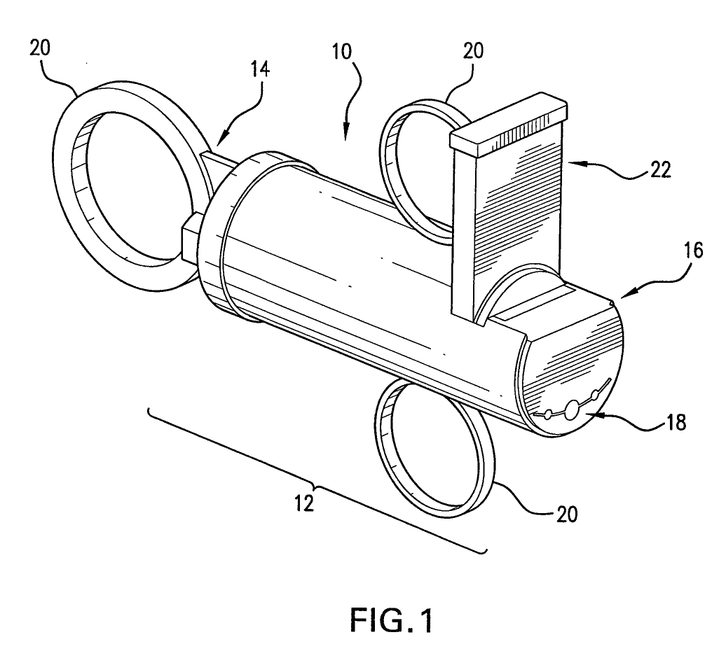

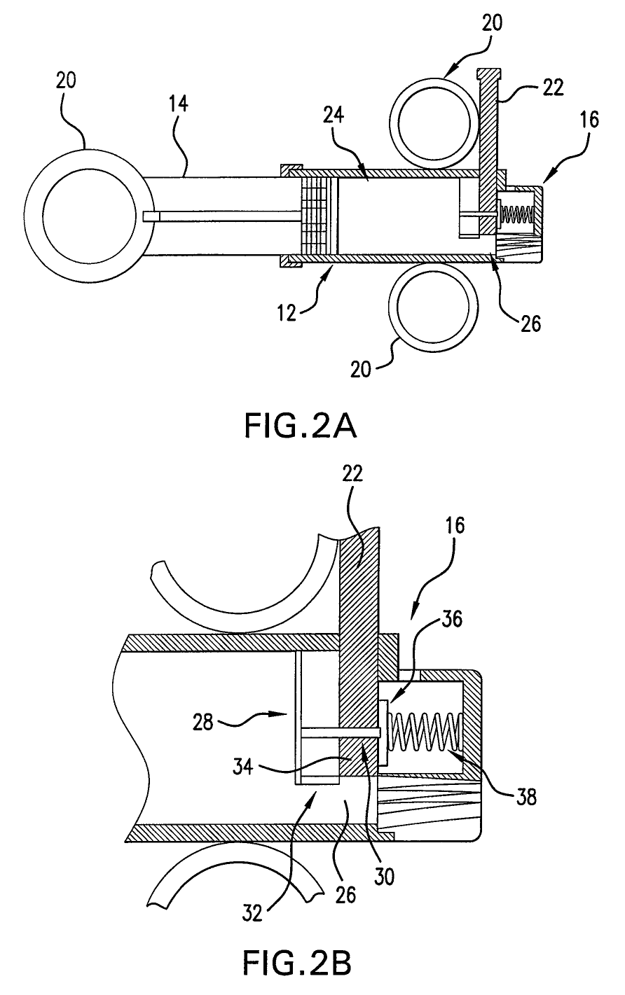

As shown in FIG. 1, the powder delivery device 10 of the present invention comprises a housing 12 which includes multiple interior lumens for containment of the plunger component 14, and a dispenser component 16, which includes a supply reservoir 22 and a series of variable cross-section, open-ended orifices 18. The exterior of the housing component 12 and the plunger 14 also comprise features such as finger rings 20 to accommodate user-supplied input required to actuate the device. Additionally, the geometry of the orifices 18 are selected to optimize powder flow and minimize powder clog situations. Moreover, as shown in FIG. 2A which shows a cross-sectional view of the device of the present invention, the multiple interior lumens of the housing 12 includes an interior lumen 24 and a dispersion area 26. Dispenser component 16 also provides an adaptable design, in which geometric variations of the orifices 18 are employed to optimize powder flow and dispersion for a large variety of powder substances. The geometric variations of the dispenser component 16 are quantified with the use of a dispensing ratio, between the length and diameter of the passage feature. The dispensing ratio is determined experimentally for each individual powder substance to be dispensed. The dispenser component 16 may also provide a push-lock or thread to facilitate the secure assembly of the dispensing assembly to the rest of the device.

Now referring to FIG. 2B, in one preferred embodiment, the dispenser component 16 comprises a gating component 28 including a first gate 30 and having an open end and a closed end, and a second gate 32. The measured space 34 between the first gate 30 and the second gate 32 has a defined and known volume and acts as a receptacle for a measured amount of powder. As explained in more detail below, the first and second gates work in conjunction with the inner lumens of the housing component to contain and deliver individual doses of powder to the dispersion area 26 of the housing component. The dispenser component 16 also contains a second bearing surface 36 for a return mechanism 38 to contact. In the preferred embodiment, the return mechanism is a common linear compression spring.

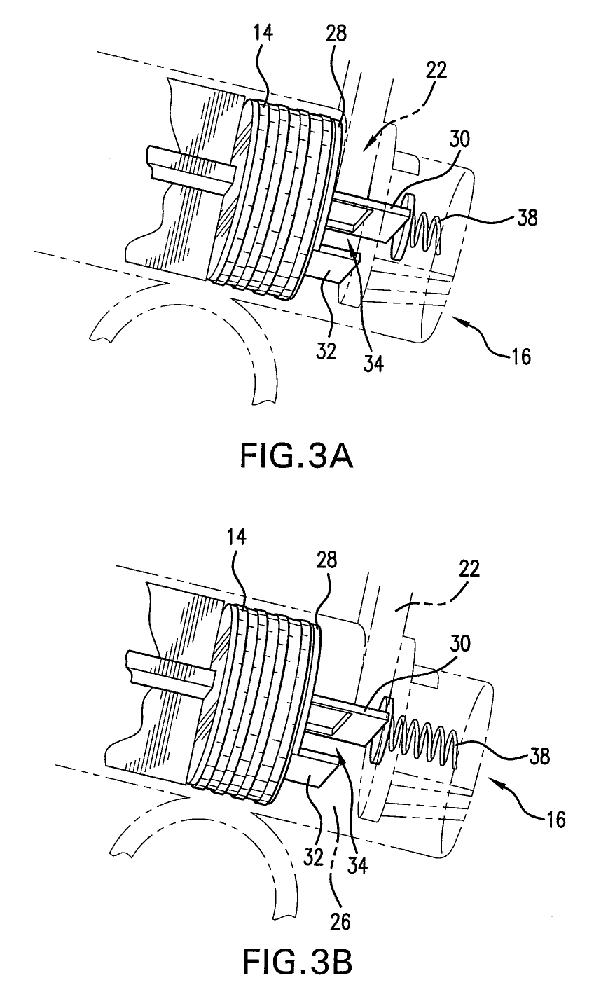

As shown in FIG. 3A, depression of plunger 14 is sufficient to displace the gating component 28, which, in turn, opens the primary gate 30, closes the secondary gate 32, and compresses the return spring 38. In the open position, the primary gate 30 allows powder to flow from the supply reservoir 22 into the measured space 34 of the device and fill it. The measured space 34 of the device is bound by the interior lumen surfaces in the housing component, interior surfaces of the gated dispenser, the open primary gate and the closed secondary gate. The amount of supply powder transferred to the dispersion area 26 of the housing is regulated by the size of the measured space 34, which is easily adapted to various dose sizes by minor changes to the geometry of surfaces and/or displacement of features on the gated dispensing component. Further, as shown in FIG. 3B, retraction of the plunger 14 from the gated dispenser 28, allows the spring 38 to expand and return the gating component 28 to its unloaded position. The primary gate 30 is closed in the unloaded position, preventing supply powder from flowing from the reservoir 22 until the next compression of the plunger component. The secondary gate 32 is open in the unloaded position causing the transfer of the measured powder dose contained in the measured space 34 to the dispersion area 26 of the housing, which replaces the powder dose that was expelled by the actuation of the plunger.

It should be noted that early in the user input plunger depression stroke, ambient air in the interior lumen 24 of the housing component 12 is displaced toward the dispersion area 26. During the plunger depression stroke, the displaced air is turbulent and aerates the powder dose present in the dispersion area before the displaced air provides sufficient force to expel the powder dose. The aeration of the powder dose also contributes to the prevention of powder clog situations. At the end of the plunger depression stroke, after the expulsion of the powder dose, the plunger displaces the gated dispenser component and a metered dose of powder is transferred to the dispersion area of the housing.

In a preferred embodiment, upon first use of the device two initial plunger compressions required before a full dose of powder is expelled from the device on the third plunger compression. A full dose is transferred to the metering area when the user depresses the plunger fully, to a physical stop. Additionally, with a controlled depression of the plunger, the preferred embodiment is capable of transferring a partial dose to the dispersion area with the limited displacement of the gated dispensing component. Again, with controlled input to the plunger, more than one dose can be transferred to the dispersion area, before the powder in the dispersion area is expelled from the device.

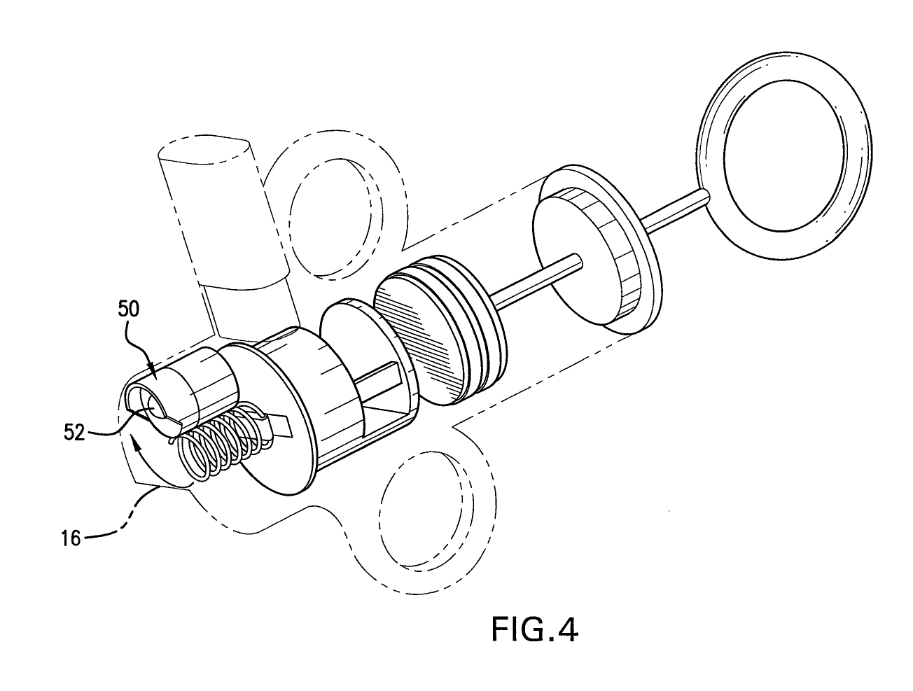

Additional features may be added to the device as described above. For example, one or more light emitting diodes (LED) or other lighting source with accompanying circuit board, and a power source may be added to the device so that illumination is provided to the target area to receive the dispensed powder, as shown in FIG. 4. As shown in FIG. 4, an LED 52 is positioned on the front of the dispenser component 16, and includes a bezel 50 that rotates to switch the LED on and off. The lighting source may be white or colored, and can be activated using conventional known circuitry. In one embodiment, an LED light source is oriented in the housing such that illumination is directed at the target area of the powder dispersion. In this embodiment the housing is comprised of multiple components, such as a multiple-lumen main component, an end cap, and a dispersion cap to facilitate the assembly and containment of the LED(s), circuit board, and power source. After assembly and/or testing of light source subcomponents, the housing components are assembled by commonly known methods, such as mating threads or adhesive bonds.

The device of the present invention can be made from any material, such as plastic, metal, or composite. Preferably the selected material is inert with respect to the powdered material that will be dispensed, and can be subjected to cleaning and/or sterilization, such as in an autoclave. The device may be manufactured by known manufacturing techniques.

The components of the device of the present invention are selected so that it is possible to deliver selected amounts of particular powders. Preferably, the device is sized so that it is capable of delivering between 0.1 and 100 grams of powder; more preferably, the device is sized so that it is capable of delivering between 1 and 10 grams of powder; and most preferably, the device is sized so that it is capable of delivering between 2 and 6 grams of powder. The powder delivery device of present invention can be manually operated using compression of the plunger to trigger delivery of the powder substance. As will be appreciated by those of skill in the art, the quantity of powder delivered varies in response to the quantity and duration of the compression force applied to the plunger by the user.

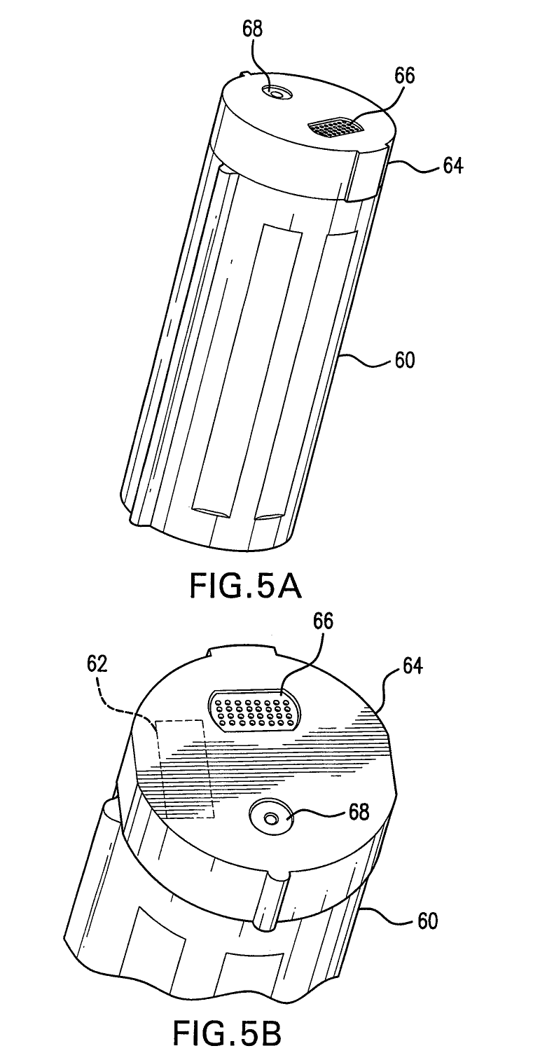

In another embodiment, the device of the present invention can take the form of a compact and portable device as shown in FIGS. 5A and 5B. In the embodiment shown in FIGS. 5A and 5B, the device comprises a powder storage component 60, which features a large inner lumen and an orifice 62 which permits powders to exit the storage component 60. A cap 64 is positioned over the orifice 62 and is rotatable so that selectable passage features 66, 68 may be selected by the user to dispense selected amounts of powders. As shown in the FIGS. 5A and 5B, the passage feature 66 is a plurality of holes designed to dispense powders in a uniform coating to a large area. Passage feature 68 is a single hole that can dispense smaller amounts of powder to discrete areas. In operation, the user rotates the cap 64 so that the desired passage feature is coincident with the orifice 62. The device is turned upside down, or squeezed, and the powder material exits the device through the selected passage feature. As will be appreciated by those skilled in the art, any number or arrangement of passage features may be incorporated into the device of the invention.

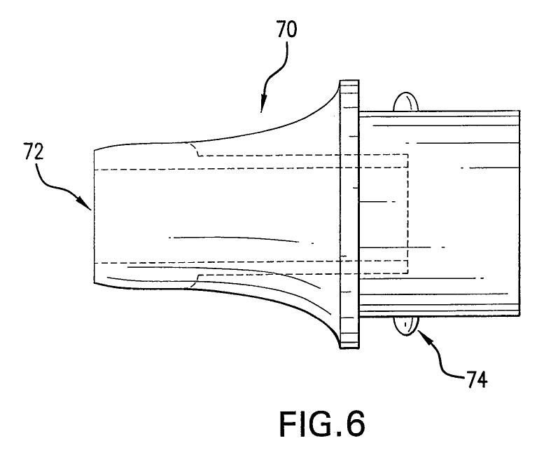

In an alternative embodiment, the rotatable cap 64 is replaced with a nozzle 70 as shown in FIG. 6. Nozzle 70 fits onto the powder storage component 60 to provide a controlled release of powder from the device. A cap (not shown) may be secured over the nozzle 70 by screw or snap means to prevent the nozzle and/or powder storage component from becoming contaminated and to prevent undesired loss of powder from the storage component. The nozzle 70 includes a passageway 72 that is designed to optimize powder flow and dispersion for a large variety of powder substances. Geometric variations of the nozzle 70 are quantified by manipulating the dispensing ratio (herein defined as the ratio between the length and diameter of the passage 72). The dispensing ratio is determined experimentally for each individual powder substance to be dispensed. In one embodiment, the dispensing ratio ranges from 0.05 to 0.5, more preferably from 0.10 to 0.25, and most preferably from 12 to 0.18. A particularly useful value of the dispensing ratio is 0.16. Additional features, such as a push-lock or thread 74, may also be incorporated into the design to facilitate the secure assembly of the nozzle onto the powder storage component.

Preferably, the device is sized so that it is capable of delivering between 0.1 and 500 grams of powder; more preferably, the device is sized so that it is capable of delivering between 1 and 50 grams of powder; and most preferably, the device is sized so that it is capable of delivering between 5 and 10 grams of powder. The powder delivery device of present invention can be manually operated using compression of the storage component 60 to deliver the powder substance to the desired area. As will be appreciated by those of skill in the art, the quantity of powder delivered varies in response to the quantity and duration of the compression force applied to the powder storage component by the user. The operation of such squeeze to dispense containers is widely know, but also easily intuitively understood.

The devices of the present invention can be made from any material, such as plastic, metal, or composite. Preferably the selected material is inert with respect to the powdered material that will be dispensed, and can be subjected to cleaning and/or sterilization, such as in an autoclave. The device may be manufactured by known manufacturing techniques. The universal operation of the powder delivery device is beneficial in a multitude of applications, outside of controlled environments, such as hospitals, were the skill level of the end-user is unknown.

The powder delivery devices of the present invention can be used for dispensing a large variety of powdered substances suitable for medicament and/or pharmaceutical use, such as analgesic powders, desiccant powders, anti-fungal powders, antibacterial powders, astringent powders, styptic powders, and the like, as well as combinations of such powders. In one embodiment, the invention can be used to deliver a clotting agent powder onto and into wounds to enhance the body's ability to stop bleeding. In one embodiment, the clotting agent is platelet powder, such as that disclosed in U.S. Pat. Nos. 4,287,087; 5,651,966; 5,891,393; 5,902,608; 5,993,804; all incorporated by reference herein. Briefly, lyophilized platelets can be made by isolating the platelets, exposing them to a fixative such as formaldehyde, and drying. Dried platelets may also be purchased commercially from Entegrion, Inc. (Research Triangle Park, N.C.) under the trade name “STASIX”.

Methods of isolation and purification of fibrin and fibrinogen are also known in the art, and fibrin and fibrinogen are also available commercially from various sources. For example, clinical grade material is sold under the tradename HAEMOCOMPLETTAN P from CSL Behring (Marburg, Germany) and TISSEEL from Baxter (Deerfield, ILL. USA). Research grade material is available from Enzyme Research Laboratories (South Bend, Ind. USA). Fibrin and fibrinogen may also be isolated according to procedures known in the art (e.g., van Ruijven-Vermeer I A, et al., Hoppe Seylers Z Physiol Chem. 360:633-7 (1979)). Fibrin and fibrinogen may also be isolated using glycine, ammonium sulfate, or ethanol precipitations that are known in the art.

In one embodiment, the powder used in the device of the present invention is a combination of fibrinogen and thrombin as disclosed in U.S. Pat. No. 6,113,948, incorporated herein by reference. Other clotting agents known in the art can be used with the device of the present invention. Examples include, but are not limited to, the fibroblast growth factor-binding protein (FGF-BP) polypeptides, such as described in U.S. application No. 20060014158, the migration-inducing peptide fragments or domains from native human fibronectin attached through a linker to hyaluronic acid, such as described in U.S. application No. 20050282747, or at least one clotting activator selected from: diatomaceous earth, inorganic silicates, ellagic acid, epinephrine and thromboplastin.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entireties.

What is claimed is:

1. A powder delivery device, comprising:
a housing;
a plunger contained in said housing; and
a dispenser component attached to an end of said housing and comprising
a reservoir containing powder material;
a gating component comprising a first gate having a closed end and an open end, and a second gate;
a metering area between said first gate and said second gate; and
one or more orifices;
said gating component having a first position wherein said second gate is closed and said open end of said first gate permits said powder material to enter said metering area from said reservoir; and a second position wherein said second gate is open and said closed end of said first gate permits said powder material in said metering area to enter said housing and exit said device through said orifices.

2. The powder delivery device of claim 1, wherein said gating component moves between said first position and said second position by a spring.

3. The powder delivery device of claim 1, wherein said plunger activates said gating component to alternate between said first position and said second position.

4. The powder delivery device of claim 1, further comprising a lighting source.

5. The powder delivery device of claim 4, wherein said lighting source is one or more LEDs.

6. The powder delivery device of claim 1, wherein said powder material is selected from the group consisting of analgesic powders, desiccant powders, anti-fungal powders, antibacterial powders, astringent powders, styptic powders, and combinations thereof.

7. The powder delivery device of claim 1, wherein said powder material is a clotting agent.

8. The powder delivery device of claim 7, wherein said clotting agent is selected from the group consisting of dried platelet powder, dried red blood cell powder, fibrin powder, fibrinogen powder, thrombin powder, fibroblast growth factor-binding protein (FGF-BP) polypeptides, migration-inducing peptide fragments, diatomaceous earth, inorganic silicates, ellagic acid, epinephrine, thromboplastin, and combinations thereof.

9. A clotting agent delivery device, comprising:
a housing;
a plunger contained in said housing; and
a dispenser component attached to an end of said housing and comprising
a reservoir containing a clotting material selected from the group consisting of dried platelet powder, dried red blood cell powder, fibrin powder, fibrinogen powder, thrombin powder, fibroblast growth factor-binding protein (FGF-BP) polypeptides, migration-inducing peptide fragments, diatomaceous earth, inorganic silicates, ellagic acid, epinephrine, thromboplastin, and combinations thereof;
a gating component comprising a first gate having a closed end and an open end, and a second gate;
a metering area between said first gate and said second gate; and
one or more orifices;
said gating component having a first position wherein said second gate is closed and said open end of said first gate permits said clotting material to enter said metering area from said reservoir; and a second position wherein said second gate is open and said closed end of said first gate permits said clotting material in said metering area to enter said housing and exit said device through said orifices.

10. The clotting agent delivery device of claim 9, wherein said gating component moves between said first position and said second position by a spring.

11. The clotting agent delivery device of claim 9, wherein said plunger activates said gating component to alternate between said first position and said second position.

12. The clotting agent delivery device of claim 9, further comprising a lighting source.

13. The clotting agent delivery device of claim 12, wherein said lighting source is one or more LEDs.

14. A method of dispensing a powder material onto a target using the device of claim 1.

15. A method of dispensing a powder material onto a target using the device of claim 9.

16. A method of treating a bleeding would, comprising the step of applying a clotting agent to said wound by the device of claim 1.

17. A method of treating a bleeding would, comprising the step of applying a clotting agent to said wound by the device of claim 9.

18. A powder delivery device, comprising:
a powder storage component having an orifice on one end of said powder storage component; and
a rotatable cap positioned over said orifice, said rotatable cap having one or more arrays of passages arranged so that said arrays can be coincident with said orifice upon rotation of said cap.

19. The powder delivery device of claim 18, wherein said powder is selected from the group consisting of analgesic powders, desiccant powders, anti-fungal powders, antibacterial powders, astringent powders, styptic powders, and combinations thereof.

20. The powder delivery device of claim 19, wherein said powder material is a clotting agent.

21. The powder delivery device of claim 20, wherein said clotting agent is selected from the group consisting of dried platelet powder, dried red blood cell powder, fibrin powder, fibrinogen powder, thrombin powder, fibroblast growth factor-binding protein (FGF-BP) polypeptides, migration-inducing peptide fragments, diatomaceous earth, inorganic silicates, ellagic acid, epinephrine, thromboplastin, and combinations thereof.

22. A method of dispensing a powder material onto a target using the device of claim 18.

23. A method of treating a bleeding would, comprising the step of applying a clotting agent to said wound by the device of claim 20.

24. A powder delivery device, comprising:
a powder storage component having an open end; and
a nozzle positioned on said open end, said nozzle having a passageway having a dispensing ratio of from 0.05 to 0.5.

25. The powder delivery device of claim 24, wherein said dispensing ratio ranges from 0.1 to 0.25.

26. The powder delivery device of claim 24, wherein said dispensing ratio ranges from 0.12 to 0.18.
